(19) United States
(12) Patent Application Publication
(10) Pub. No.: US 2010/0205048 A1
(43) Pub. Date: Aug. 12, 2010

(54) System and Method for Media Monetization and Distribution

(76) Inventor: David Etheredge, New Port Richey, FL (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/685,815

(22) Filed: Jan. 12, 2010

Related U.S. Application Data
(60) Provisional application No. 61/143,853, filed on Jan. 12, 2009.

(51) Int. Cl. G06Q 30/00

(52) U.S. Cl. 705/14.4

(57) ABSTRACT

A system and method for media monetization and distribution, which includes at least a monetization engine, system and method, which includes at least one database of at least one media assets, at least one user defined mini-site utilizing at least one of the media assets, a recommendation engine that matches the mini-sites with at least one advertisement, and a delivery engine that integrates the at least one advertisement with the mini-site and allows for the monitoring of the integrated advertisement.

### CROSS-REFERENCE TO RELATED APPLICATION

This application claims priority to U.S. Provisional Patent Ser. No. 61/143,853, entitled “System And Method For Media Monetization And Distribution,” filed Jan. 12, 2009, the disclosure of which is incorporated by reference herein as if set forth in its entirety.

### FIELD OF THE INVENTION

The present invention is directed to a monetization engine and, more particularly, to an engine for the generation of advertising opportunities, and a method of making and using same.

### SUMMARY OF THE INVENTION

The present invention includes at least a monetization engine, system and method, which includes at least one database of at least one media assets, at least one user defined mini-site utilizing at least one of the media assets, a recommendation engine that matches the mini-sites with at least one advertisement, and a delivery engine that integrates the at least one advertisement with the mini-site and allows for the monitoring of the integrated advertisement.

Thus, the present invention provides an engine, system and method that allows for the monetization of media through the placement of advertisements on media rich mini-sites associated with third party web sites.

### BRIEF DESCRIPTION OF THE FIGURES

The present invention will be described hereinbelow in conjunction with the following figures, in which like numerals represent like items, and wherein:

FIG. 1 is a flow diagram illustrating an exemplary embodiment of the present invention;

FIG. 2 is a flow diagram illustrating an exemplary embodiment of the present invention; and

FIG. 3 illustrates a mini-site of the present invention.

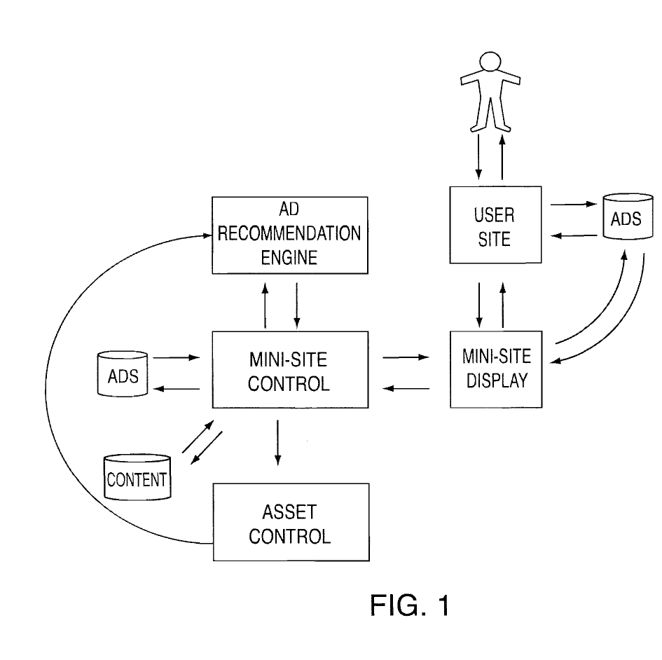

### DETAILED DESCRIPTION OF THE INVENTION

In the description that follows, the invention is described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that several of the acts and operations described hereinafter may also be implemented in hardware.

It is to be understood that the figures and descriptions of the present invention have been simplified to illustrate elements that are relevant for a clear understanding of the present invention, while eliminating, for purposes of clarity, many other elements found in a typical system and method. Those of ordinary skill in the art will recognize that other elements are desirable and/or required in order to implement the present invention. However, because such elements are well known in the art, and because they do not facilitate a better understanding of the present invention, a discussion of such elements is not provided herein. The disclosure herein below is directed to all such variations and modifications to planning technologies known, and as will be apparent, to those skilled in the art.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the fame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for a particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which are approved by one or more entities external from, but affiliated with, the specific endorser.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

At present, there is a need for a platform or engine to allow for the obtaining of an endorsement, or endorsed ad, in any of the above circumstances, either from a specific individual, a specific entity, an affinity brand, a marketing partner, or a sponsor. In the present invention, an

The database captures certain brands and information related thereto in a common database, such as all major league baseball past and present players, including statistics, video, and pictures of those players affiliated with the names of those players, in addition to any endorsement limitations on those players. The database may include media assets that may be associated with audio-visual works. The database may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video. The database may also include, associated with the brand, exclusion, inclusions, or preferences for the use of the brand or particular items of information associated with the brand in the database. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

Further, media assets in the database may be marked with different payment schema based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the database, such as geography, but additionally can use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” may be developed in the database for a particular brand. Such a profile may include any of a myriad of information, both stored in the database and having external references outside the database from within the database, including but not limited to psychological profiles of typical users of that brand (which may include values, motivations, wants, and needs of such users, and which may be assessed based on inferences from on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling may provide for local or national focus and maintained in the database as an associated media asset with a particular brand, and best matches for certain brands may be selected according to such polling results.

Improvement in later stage tracking for improved ad targeting may be enabled through the delivery engine (mini-site control) and will allow for greater efficiency the trafficking of ads during or after or with or without interface with the delivery engine. Efficiency may be obtained by tracking, for example, the data intelligence for use with the delivery of the creative. By way of non-limiting example, data intelligence may include click-thru rate, post-click conversion rate, post-impression activities, as well as geography, demographic and daypart information. Gathered data intelligence may be used as individual properties in conjunction with each other to form or produce the level of intelligence needed to achieve the desired efficiencies. By way of further example, data intelligence may also include information regarding the number of impressions an ad has received, the elapsed time between an impression or a click.

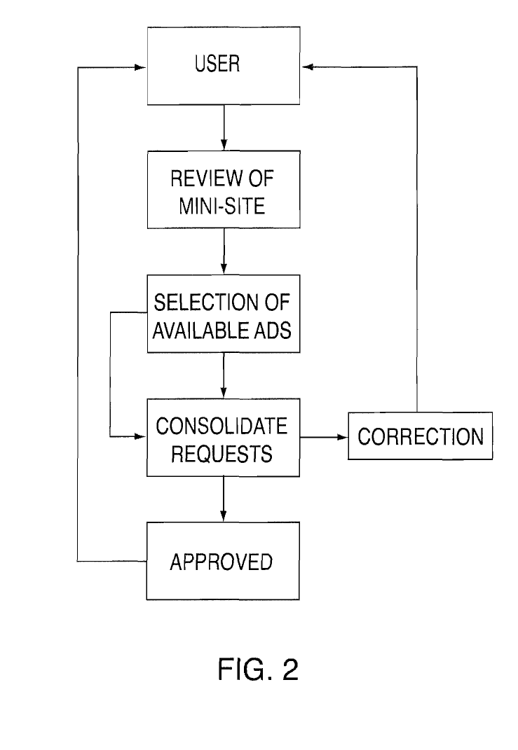

To efficiently access and use certain aspects of the present invention, a user management system in accordance with the present invention is shown in FIG. 2. The user management system may be utilized, for example, for collecting, storing, and disseminating information and ideas, such as, for example, at least one asset. Users may search, view, and organize information related to at least one asset. Administrators may interact with the user management system to add information, provide interactive guidance on asset selection and control the flow of information, for example. Administrators may additionally control the use and content of the user management system. The user management system may include network access to administration function modules, such as for the review of a mini-site and for the selection of ads, at least one database, and a request consolidation module. The user management system may also include a approval module, for example.

The user management system of FIG. 2 may also include a multiplicity of integrated components and at least one logical and/or relational database. Information, such as assets, in the user management system may necessitate or include one or more of the functions or modules of FIG. 2, depending on the requirements of the user. Furthermore, for each piece of information, there may be a set of data attributes that may be tracked and that may be unique to the user management system. Some of the data attributes for each piece may be required, and others may be used at the administrator's discretion.

The user management system may utilize, for example, dynamic link libraries (DLL) that link the information data, such as the administrator's choice of component and fields, and HTML, xml, or ASPX templates, for example. These DLLs may process the HTML templates before presentation to a user of the interface, replacing tags and information in the HTML template with the defining attributes captured. Thereby, the administrator may have control of the layout and presentation of the data, and the user management system may thus ensure that capture validation and storage of data is consistent across all information.

Security access control may authenticate a user. Users of the system may log into the system via an internet portal and access the system through the protections of a user name and password, for example. In addition, the security module may provide access control once the user has been authenticated. Multiple levels of access control may be defined. For example, one level may be for system administrators and another may be for a client user. System administrators may have full access to the application to add, delete and update the data, and client users may have limited access.

The user management system may also allow for users to access documents and information, such as assets, in at least one defined group. Further, each at least one defined group may have access to certain information further delineated between at least one user assigned to the at least one group. A user group may be defined by the system administrator and may contain at least one authorized user of the system. Within the defined user group may be information associated to the group. Although the same information may be shared by more than one user, the associated information will generally be associated with just one user group. Similarly, the information associated with the user group may be associated to at least one of the users assigned to the user group.

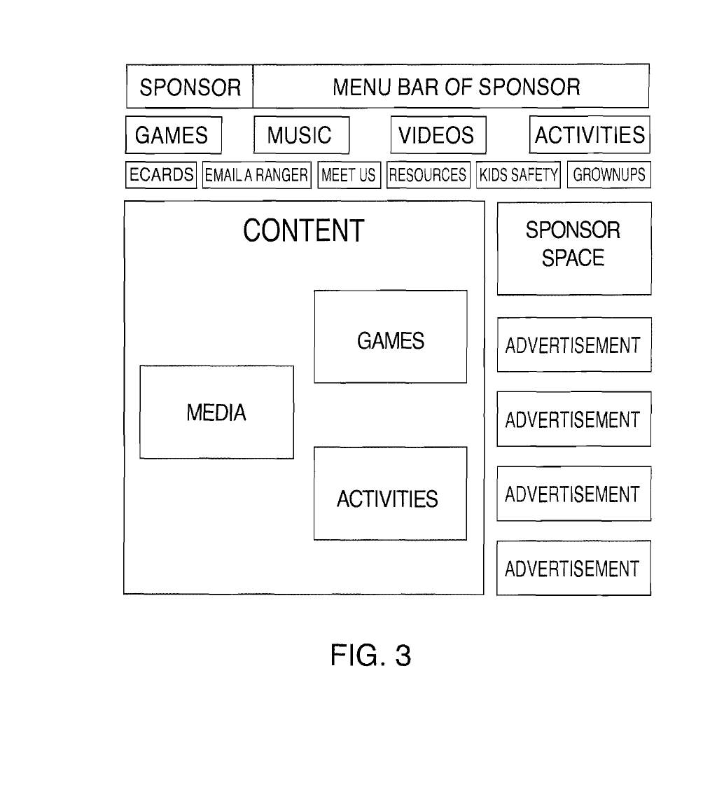

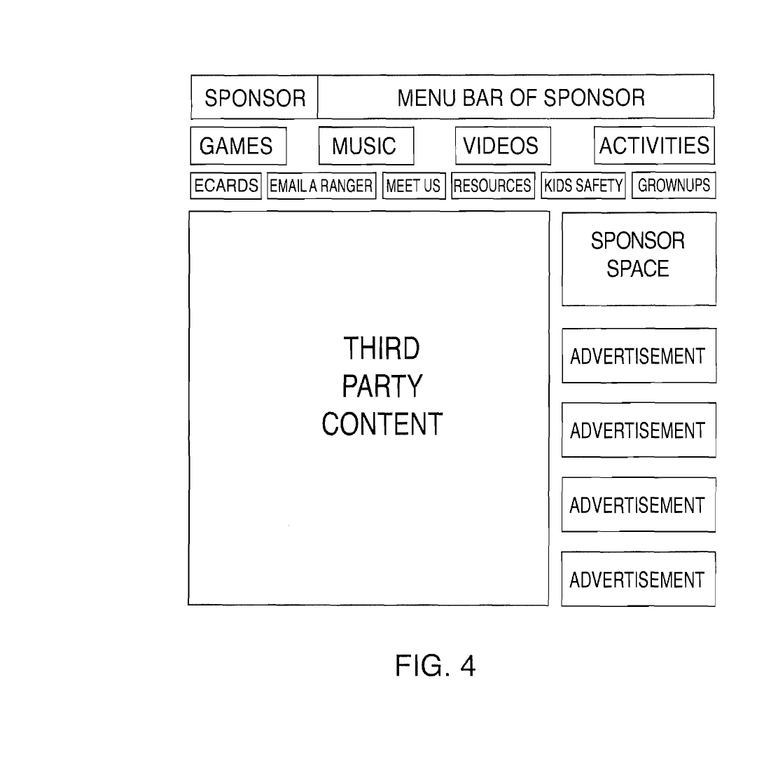

A mini-site, as illustrated in FIG. 3, may include co-branding logo(s) which may be added to at least one website and may allow traffic to be directed to at least one main site (with a loose connection to referring site) from at least one reference associated with the mini-site.

In an embodiment of the present invention, a mini-site may be installed on at least one referred machine to avoid problems with divergent code bases, intellectual property concerns, hanging of content and updating. A user may interact with a mini-site display and review and offering into the delivery engine at least one suggested ad schema.

In an embodiment of the present invention, a single mini-site may be rebranded in real time through the actions of a user through the mini-site display and/or through the recommendation engine based, in part on the attributes and characteristics discussed above. Aspects of the mini-site which may be altered in real-time may include, for example, headers and co-branded logos and content.

The present invention may also provide for a clearing house for media providers and those looking to add content to one or more websites, whether or not a mini-site. In an embodiment of the present invention, a concept portal and content embedded with widgets may be utilized though the mini-site display and may be control and disseminated by a user of the system.

Monetization of the present invention may be based on traffic history within at least one mini-site and may be restricted by geographical area, for example. Further, as would be understood by those skilled in the art, the present invention may allow for password of code controls on access and click-throughs and may allow for tiered pricing for hits or actual click-throughs from the target mini-site.

The present invention may also provide for embedded sponsorship opportunities, such as “mom and pop” stores. Such establishments may purchase at least one portion of at least one mini-site with the administrator of the present invention buying out the remainder or unutilized/underutilized portion of the mini-site. The site administrator may then buy out the remaining mini-site ad space or the purchaser/“mom and pop” of the mini-site may sell the unused space.

Media owners may have control over the distribution of their media and the association of advertisements through the use of the approval module and may have access to the real-time display of each mini-site through the mini-site display module, for example.

Furthermore, advertisers may restrict ad usage on certain types of mini sites, through, for example, pre-set limitations read or otherwise entered into the recommendation engine. Similarly, a user of the system my visually review any mini-site and may have access to change any attribute of a given mini-site.

The association of keywords with the multiple document/object types contained within the user management system allows a user to properly categorize a particular object, and allows the user to categorize the object as it is entered into the user management system or as it is created using the user management system, or allows the user to view within the user management system. Thereby, the present invention provides a highly accurate classification within the user management system, which may be based on the familiarity of the user with the subject matter.

A user who chooses to associate a keyword to a new object may be taken to the keyword association list window. The keyword association window may provide access to all objects contained within the user management system. The window may display the keyword chosen associated with one or more objects within the user management system, and a table containing a listing of the objects contained within the user management system. The objects may be listed in any order, including alphabetically by keywords or associated keyword, author, title and file type, for example. Each listed object may also contain an option box allowing the user to click whether or not that object should be associated with the presently selected keyword. Once one or more objects have been selected to be associated with the keyword, unselected objects may be removed from being associated with the keyword. This function will update the user management system with the association of the keyword with the objects selected.

As discussed above, the present user management system may provide for administrative control over the contents of, and access to, the user management system. Additionally, a user may be an administrator and may be responsible for adding, removing and maintaining documents or content within the user management system. Additionally, an administrator may control user access and other contents of the user management system. Thus, the user management system may provide an administration log-in window. This window may allow authorized personnel to enter a valid user name and password which may allow them to access the user management system. Successful log-in may lead the user to the user management system administration main window. This main window may include links allowing the user to navigate to the home main menu, to the links page, the editors choice administration page, the reports window and the user maintenance window, for example. The main window may also provide a listing of objects contained in the user management system. The user may further have the ability to add objects to the user management system, remove existing objects from the user management system, or access existing documents for the purposes of editing, such as to assign or update association criteria, for example. By clicking the add new link button in the administration main window, the user may move to the administration add document window.

This window may allow the administrator to add new objects/documents to the user management system. The administrator may choose to designate characteristics, such as file type, document type, title, description and author, for example. The administrator may also add a file by completing, in the file field, the location of the document, or by selecting the document by clicking the browse button to search for the document by techniques known to those skilled in the art.

The delete document window may include a listing of all or a portion of the documents included in the user management system. This list of documents may further be sorted by year, source, author, title and file type, for example. The list of documents in this window may also include an option box associated with each document. This option box may allow the user to choose and select documents desired to be deleted from the user management system. If one or more documents are selected by checking the option box associated with the particular document, those documents may be deleted from the user management system by clicking the delete button at the bottom, which may be of the delete document window.

Once a document is added to the user management system, such as in the exemplary manners discussed above, the administrator may specify unique document information to further refine user searches. An administrator may be encouraged to associate attributes and keywords, for example, and meetings with each document to provide users with more complete research results.

As previously stated, once a document is added to the user management system, an administrator may specify unique document information to further refine uses searches and the association between uses and buckets, for example. The associated keywords portion, as provided in the document maintenance window for the document currently being added or edited by the administrator, may allow the administrator to add or modify the associated keywords by clicking the keyword maintenance button to provide access to the keyword administration window.

Further, keywords may be associated with the documents contained in the user management system through the keyword administration window. The keyword administration window may be divided in two portions. The first portion may contain keywords already included within the user management system, while the second portion may provide functionality allowing the association of existing keywords with existing and newly created documents within the user management system. In the first portion, keywords already existing in the user management system, as entered by the administrator and as more thoroughly described above, may be organized in top level and lower level categories, each with sublevel access using the plus symbol icon as described above.

The user management system may further provide an administrator with access to reporting/auditing functionality. Audit reports available to the administrator in the report list window may include, for example; summary statistics, user browser environment, referral report, individual user usage and document tracking, including object editing and copying, for example. These reports may also be accessed by clicking the hyperlink entitled the same. For example, by clicking the hyperlink entitled summary statistics, the administrator may access to the summary statistics report window. The summary statistics report window may include general statistics about the users and uses of the user management system. The summary statistics window may include a table entitled “general statistics” which may provide a count of the visitors or users of the user management system for the chosen day, the number of visitors for the chosen week, the number of visitors for the chosen month, the number of visitors for the given year, and the total visitors or users of the user management system since its inception, for example. The statistics report may also provide a table outlining uses. The site usage report may outline the percentage of users revisiting various sections of the user management system.

What is claimed is:

1. An media monetization and distribution system, comprising:
an ad recommendation engine associated with at least one processor and having one or more open inputs for inputting of advertisements;
at least one mini-site control for obtaining advertisements across at least one computing network in accordance with the ad recommendation engine;
at least one mini-site display comprising at least one computing memory for storing information obtained via said at least one mini-site control and corresponded to the ad recommendation engine; and
at least one asset control engine, wherein an output of said asset control engine is modification to one or more mini-site displays dependent on the ad recommendation engine, and wherein the output is dependent solely on the information in said at least one mini-site control.
